(19) United States
(12) Patent Application Publication
(10) Pub. No.: US 2004/0142083 A1
(43) Pub. Date: Jul. 22, 2004

(54) Method for extracting oil from bran or husk

(76) Inventor: Chiu Lin Chen, Chong Ho City (TW)

Correspondence Address: Chiu Lin Chen, P.O. Box 10-69, Chong Ho, Taipei, 235, TW

(21) Appl. No.: 10/347,843

(22) Filed: Jan. 17, 2003

(51) Int. Cl. A23L 1/22

(52) U.S. Cl. 426/534

(57) ABSTRACT

A method for extracting oil material from bran includes a filter member having a number of orifices, for supporting bran or husk or chaff of grains. One or more burned elements are then disposed on top of the bran, to burn the bran, and to heat the oil material of the bran to fluid status, and then to collect the oil material in a receptacle. One or more further filter members may further be disposed between the bran and the receptacle. The oil material may further be heated before the oil material is packaged for marketing purposes.

### BACKGROUND OF THE INVENTION

1. Field of the Invention

The present invention relates to a method, and more particularly to a method for extracting oil materials from bran, husk or chaff.

2. Description of the Prior Art

Typically, bran, husk or chaff of such as grains are waste materials, and will normally be burned or simply discarded away without being used.

The bran, husk or chaff of grains normally include about 16% of grease or oil materials, and about 11% water therein. In addition, the bran, husk or chaff of grains normally include about 29% of a chemical material for restraining the growing of black pigment. However, the oil and/or the chemical materials of the bran, husk or chaff of grains may not be suitably used.

The present invention has arisen to mitigate and/or obviate the afore-described disadvantages of the conventional usages for bran, husk or chaff of grains.

### SUMMARY OF THE INVENTION

The primary objective of the present invention is to provide a method for extracting oil materials from bran, husk or chaff.

In accordance with one aspect of the invention, there is provided a method for extracting oil material from bran, the method comprising providing a first filter member having a plurality of orifices formed therein, disposing the bran on said first filter member, providing and disposing burned element on top of the bran, to burn the bran, and to heat the oil material of the bran to fluid status, and collecting the oil material.

A second filter member may further be provided and disposed below the first filter member, to filter the bran. A third filter member may further be provided and disposed below the second filter member, to filter the bran. A receptacle may further be provided and disposed below the third filter member, to collect the oil material.

The oil material may further be heated before the oil material is packaged for marketing purposes.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a device for conducting processes of a method in accordance with the present invention;

FIG. 2 is an exploded view of the device;

FIG. 3 is a perspective view similar to FIG. 1, illustrating the operation of the method;

FIG. 4 is a plan view of the device, in which a portion of the device is cut off to show the inner portion of the device;

FIG. 5 is a perspective view illustrating the operation of the method;

FIG. 6 is a plan view of the device, similar to FIG. 4, illustrating the operation of the method;

FIG. 7 is a perspective view illustrating the heating process of the method; and

FIG. 8 is a perspective view illustrating the packing of the method.

### DETAILED DESCRIPTION OF THE PREFERRED EMBODIMENT

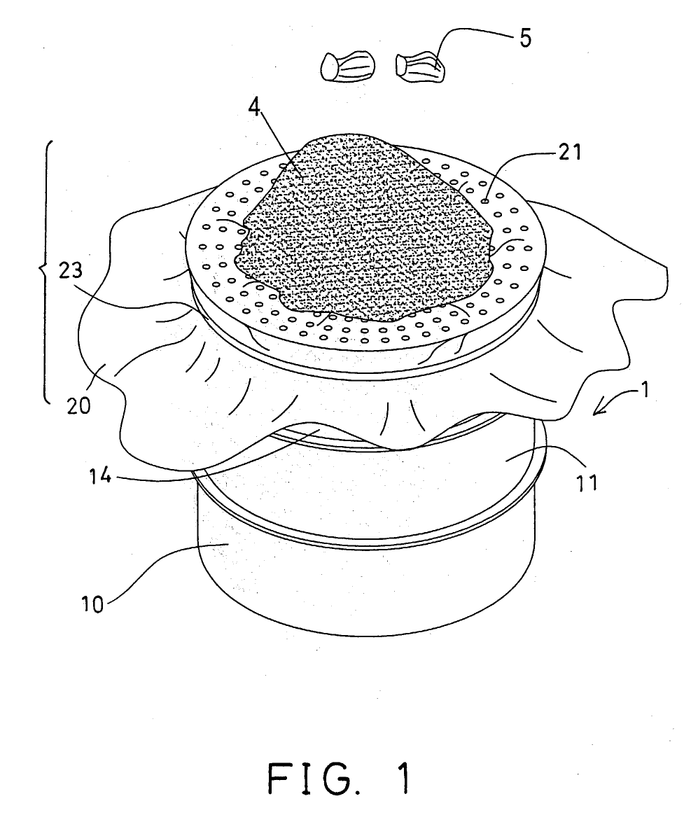

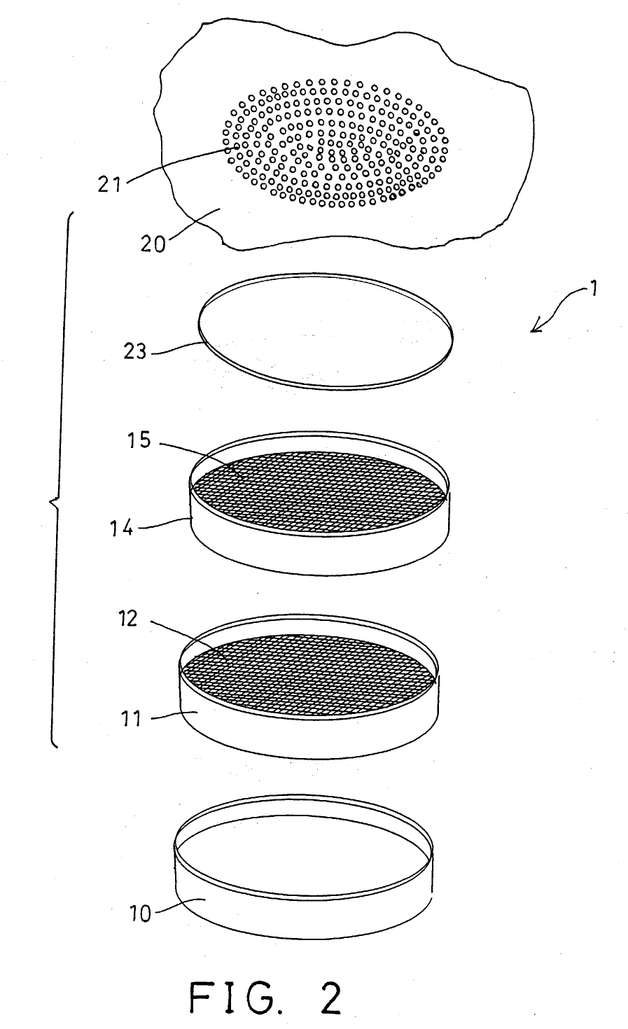

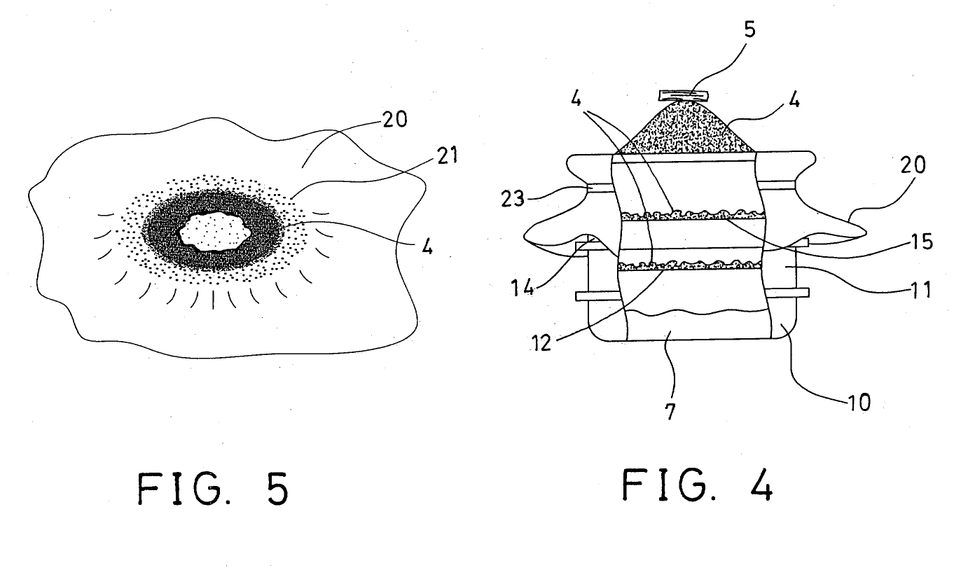

Referring to the drawings, and initially to FIGS. 1-4, a method in accordance with the present invention is primarily provided for extracting oil materials 7 (FIGS. 4 and 6-8) from husk, chaff or bran 4, and comprises a device 1 for conducting processes of the method.

The device 1 includes a receptacle 10 for receiving the oil materials 7, a filter member 11 disposed on and supported by the receptacle 10 and having a screen 12 provided therein. The screen 12 of the filter member 11 includes a mesh number of about 60.

Another filter member 14 is further provided and disposed on and supported by the filter member 11 and having a screen 15 provided therein. The screen 15 of the filter member 14 includes a mesh number of about 40. The filter members 11, 14 are provided for filtering the husk, chaff or bran 4.

A further filter member 20 is further provided and disposed on and supported by the filter member 14 and having a number of orifices 21 formed therein or having a mesh number of about 20. The filter member 20 is secured onto the filter member 14 with such as a fastener belt 23 or the like.

The filter member 20 may also be provided or used to filter the husk, chaff or bran 4. For example, the filter member 20 may be made of or formed of 45 pounds of paper, and may have the orifices 21 formed therein by piercing the paper filter member 20 with such as pins or nails, etc.

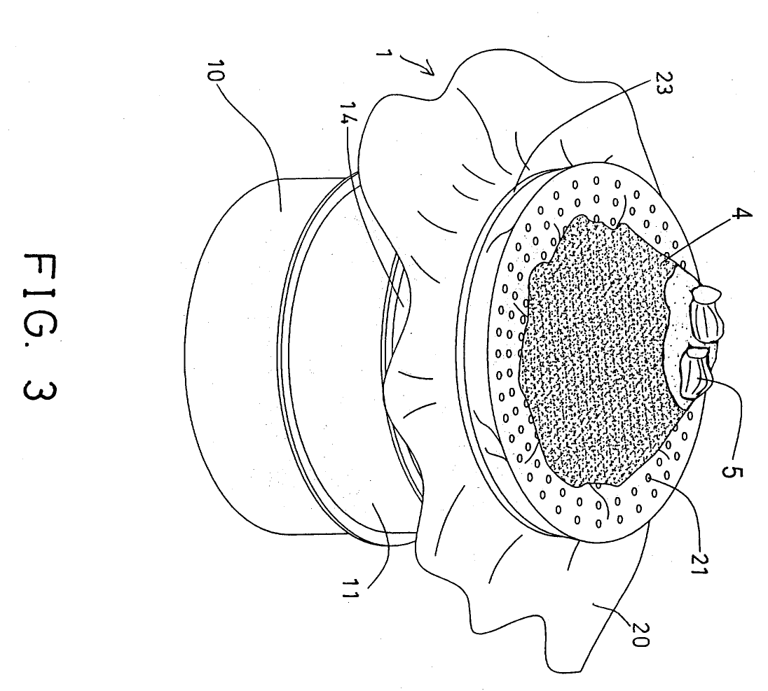

The husk, chaff or bran 4 is disposed on top of the filter member 20. One or more burned element 5, such as well burned or fully heated charcoal materials 5 are then disposed on top of the bran 4, to heat or burn the bran 4 (FIGS. 3, 4). The bran 4 includes a large proportion of carbohydrate which may further fire the charcoal materials 5.

The bran 4 may thus be burned from the upper portion toward the lower portion thereof. The grease or oil material 7 from the bran 4 may also be heated into fluid status at a temperature of about 60° C., and may then be gradually absorbed by the paper filter member 20 (FIG. 5).

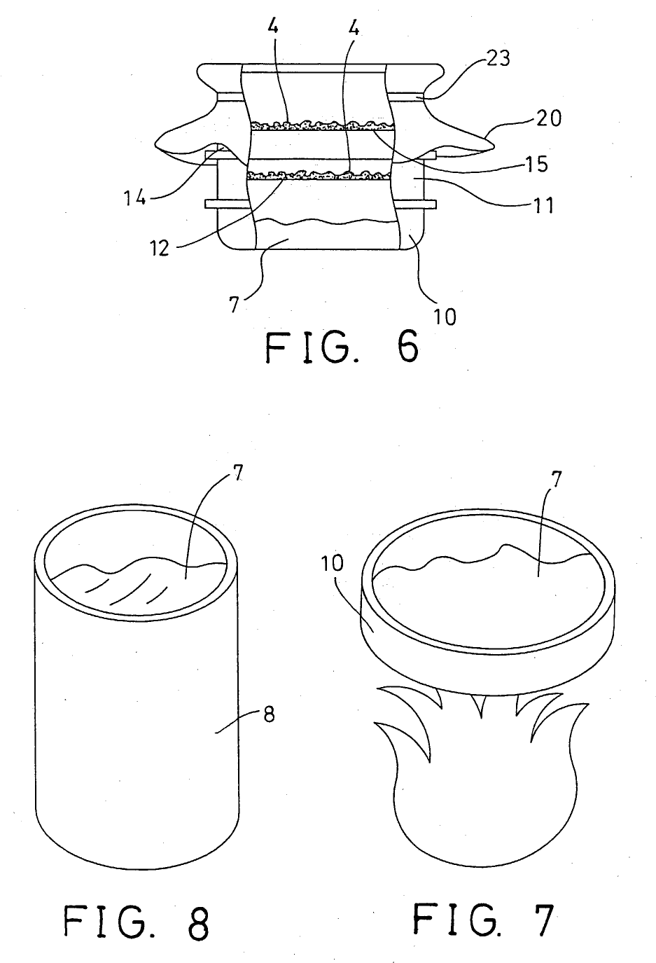

After the grease or oil material 7 from the bran 4 has been fully absorbed by the paper filter member 20, the grease or oil material 7 from the bran 4 may then flow downwardly through the orifices 21 of the filter member 20, and the screens 15, 12 of the filter members 14, 11, and will then be collected within the receptacle 10 (FIGS. 4, 6). The heated grease or oil material 7 from the bran 4 may normally include a dark brown color.

The filter members 20, 14, 11 may be used to filter the bran 4, and/or the partially burned bran 4, to prevent the bran 4, and/or the partially burned bran 4 from being moved through the filter members 20, 14, 11, and from being collected within the receptacle 10, such that a clean grease or oil material 7

As shown in FIG. 7, the grease or oil material 7 collected in the receptacle 10 may then be heated again to form the final oil product 7, which will then be packed or received in containers 8 for marketing purposes.

It is to be noted that the bran 4 is waste materials that have no fees or costs. In addition, the device 1 may be used for a long time. Only the paper filter member 20 will be consumed after being used for a period of time, such that the manufacturing cost for the oil material is greatly lowered.

Accordingly, the method in accordance with the present invention may be used for extracting oil materials from bran, husk or chaff.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A method for extracting oil material from bran, said method comprising:
providing a first filter member having a plurality of orifices formed therein,
disposing the bran on said first filter member,
providing and disposing burned element on top of the bran, to burn the bran, and to heat the oil material of the bran to fluid status, and
collecting the oil material.

2. The method as claimed in claim 1 further providing and disposing a second filter member below the first filter member, to filter the bran.

3. The method as claimed in claim 2 further providing and disposing a third filter member below the second filter member, to filter the bran.

4. The method as claimed in claim 3 further providing and disposing a receptacle below the third filter member, to collect the oil material.

5. The method as claimed in claim 1 further comprising heat the oil material.

6. The method as claimed in claim 1 further comprising packaging the oil material.

7. The method as claimed in claim 1, wherein the first filter member is made of paper.
